(19) United States
(12) Patent Application Publication
(10) Pub. No.: US 2017/0213486 A1
(43) Pub. Date: Jul. 27, 2017

(54) FLEXIBLE DISPLAY APPARATUS

(71) Applicant: BOE TECHNOLOGY GROUP CO., LTD., Beijing (CN)

(72) Inventor: Weifeng Zhou, Beijing (CN)

(73) Assignee: BOE TECHNOLOGY GROUP CO., LTD., Beijing (CN)

(21) Appl. No.: 15/325,435

(22) PCT Filed: May 20, 2016
(86) PCT No.: PCT/CN2016/082899

§ 371 Date: Jan. 10, 2017

(30) Foreign Application Priority Data
Jul. 7, 2015 (CN) 201520484829.3

(51) Int. Cl. G09F 9/30; B32B 7/12

(52) U.S. Cl. CPC G09F 9/301; B32B 7/12; B32B 2457/20; H04M 1/0268

(57) ABSTRACT

The present application discloses a flexible display apparatus comprising at least a first flexible panel layer and a second flexible panel layer, and a lubricant layer between the first flexible panel layer and the second flexible panel layer. The first flexible panel layer and the second flexible panel layer are capable of sliding relative to each other when the flexible display apparatus is bent.

### CROSS-REFERENCE TO RELATED APPLICATION

This application claims priority to Chinese Patent Application No. 201520484829.3, filed Jul. 7, 2015, the contents of which are incorporated by reference in the entirety.

### TECHNICAL FIELD

The present invention relates to display technology, more particularly, to a flexible display apparatus.

### BACKGROUND

In recent years, flexible display apparatuses have found a wide range of applications, for example, in smart cards, electronic paper display, smart labels, mobiles phones, personal digital assistance (PDAs), digital cameras, on-board displays, notebook computers, on-wall televisions, etc.

FIG. 1 is a diagram illustrating the structure of a conventional flexible display apparatus. Referring to FIG. 1, the flexible display apparatus in the embodiment includes a plurality of flexible panel layers, e.g., a flexible display layer 4, and one or more other flexible panel layers 5 stacked on one or two sides of the flexible display layer 4. Examples of these flexible panel layers 5 include a touch control layer, an anti-scratch layer, an anti-static layer, etc. As shown in FIG. 1, the conventional flexible display apparatus includes an adhesive layer 6 adhering the flexible display layer 4 and other flexible panel layers 5 together.

### SUMMARY

In one aspect, the present invention provides a flexible display apparatus comprising at least a first flexible panel layer and a second flexible panel layer, and a lubricant layer between the first flexible panel layer and the second flexible panel layer; wherein the first flexible panel layer and the second flexible panel layer are capable of sliding relative to each other when the flexible display apparatus is bent.

Optionally, the first flexible panel layer and the second flexible panel layer overlapping with each other in plan view of the flexible display apparatus forming an overlapping zone; the lubricant layer is in contact with the first flexible panel layer substantially throughout the overlapping zone and in contact with the second flexible panel layer substantially throughout the overlapping zone.

Optionally, the first flexible panel layer has a larger dimension than those of the lubricant layer and the second flexible panel layer along at least a first direction; and the lubricant layer has a larger dimension than that of the second flexible panel layer along at least the first direction.

Optionally, the first direction is a principal curvature direction.

Optionally, the flexible display apparatus further comprises at least one lubricant storage recess for storing lubricant in a peripheral region of at least one of the first flexible panel layer and the second flexible panel layer.

Optionally, the flexible display apparatus comprises two lubricant storage recesses.

Optionally, the first flexible panel layer, the second flexible panel layer, and the lubricant layer are substantially coextensive with each other.

Optionally, the lubricant layer has a thickness in the range of about 10 μm to about 300 μm.

Optionally, the lubricant layer has a thickness in the range of about 40 μm to about 60 μm.

Optionally, the first flexible panel layer is a flexible display layer for image display.

Optionally, the flexible display layer is selected from the group consisting of a flexible organic light emitting display layer, flexible liquid crystal display layer, and flexible electronic paper display layer.

Optionally, the flexible display layer has a larger dimension than those of the lubricant layer and the second flexible panel layer along at least a first direction; and the lubricant layer has a larger dimension than that of the second flexible panel layer along at least the first direction.

Optionally, the flexible display layer, the second flexible panel layer, and the lubricant layer are substantially coextensive with each other.

Optionally, the second flexible panel layer is selected from the group consisting of a touch control layer, an optical layer, a polarization layer, an anti-scratch layer, a fingerprint resistant layer, an anti-glare layer, a heat dissipating layer, and an anti-static layer.

Optionally, the lubricant layer is made of a transparent lubricant.

Optionally, the transparent lubricant is made of a thickener and at least one of a mineral oil and a lubricating oil.

Optionally, the transparent lubricant has an enriched state color selected from the group consisting of transparent, semi-transparent, white, black, and beige.

Optionally, the flexible display apparatus comprises a plurality of flexible panel layers and a plurality of lubricant layers, each lubricant layer between each pair of two adjacent flexible panel layers.

Optionally, the lubricant layer is at least coextensive with a display region of the flexible display apparatus.

Optionally, the overlapping zone is at least coextensive with a display region of the flexible display apparatus.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the structure of a conventional flexible display apparatus.

FIG. 2A is a diagram illustrating the structure of a flexible display apparatus in a flat state in some embodiments.

FIG. 2B is a diagram illustrating the structure of a flexible display apparatus in a curved state in some embodiments.

FIG. 3A is a diagram illustrating the structure of a flexible display apparatus in a flat state in some embodiments.

FIG. 3B is a diagram illustrating the structure of a flexible display apparatus in a curved state in some embodiments.

FIG. 4A is a diagram illustrating the structure of a flexible display apparatus in a flat state in some embodiments.

FIG. 4B is a diagram illustrating the structure of a flexible display apparatus in a curved state in some embodiments.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

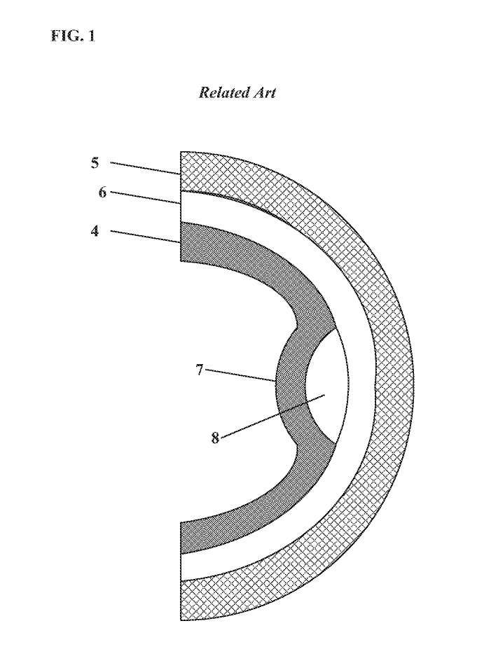

The present disclosure identifies several issues with the conventional flexible display apparatus. In a curved state, various flexible panel layers of the conventional flexible display apparatus have different radii of curvature, thus inducing bending stress in the flexible display apparatus. The magnitude of bending stress and strain of each flexible panel layer depends on the position and elastic modulus of each layer. When the radius of curvature decreases below a certain threshold value, the adhesives holding the flexible panel layers together can no longer constrain the panel panels from deformation, resulting in defects such as wrinkles 7 and bubbles 8 (FIG. 1). Moreover, the flexible panel layers are prone to scratch damages due to small particles such as dust between the flexible panel layers and the adhesive layer. When the display apparatus is curved, the small particles may easily scratch the flexible panel layer, deteriorating the display apparatus.

The present disclosure provides a novel and superior flexible display apparatus that can withstand a higher level of bending stress and strain. Moreover, the present flexible display apparatus is free of defects resulting from bending stress and strain such as wrinkles, bubbles and scratching damages between flexible panel layers when they are bent.

In some embodiments, the flexible display apparatus includes a plurality of flexible panel layers, one of which is a flexible display layer for image display. For example, the flexible display layer typically includes an array substrate (e.g., having an array of thin film transistors) and a packaging substrate (e.g., a color filter substrate) opposite to the array substrate. The array substrate and the packaging substrate are assembled together to form the flexible display layer. The flexible display layer includes a display region for image display and a peripheral region. Optionally, the plurality of flexible panel layers are substantially coextensive with the flexible display layer. Optionally, the plurality of flexible panel layers are at least substantially coextensive with the display region of the flexible display layer.

In some embodiments, the flexible display apparatus includes a first flexible panel layer and a second flexible panel layer, and a lubricant layer between and in contact with both the first flexible panel layer and the second flexible panel layer. The first flexible panel layer and the second flexible panel layer overlap with each other in plan view of the flexible display apparatus forming an overlapping zone. Optionally, the overlapping zone is at least coextensive with the display region of the flexible display layer.

In some embodiments, the lubricant layer is in contact with the first flexible panel layer substantially throughout the overlapping zone and in contact with the second flexible panel layer substantially throughout the overlapping zone. For example, the lubricant layer is in contact with a side of the first flexible panel layer proximal to the lubricant layer substantially throughout the overlapping zone, and in contact with a side of the second flexible panel layer proximal to the lubricant layer substantially throughout the overlapping zone. Optionally, the lubricant layer has a substantially uniform thickness. Optionally, the lubricant layer is substantially free of bubbles. Optionally, the lubricant layer is substantially coextensive with the first flexible panel layer and the second flexible panel layer. Optionally, the flexible display apparatus includes a lubricant layer between each pair of two adjacent flexible panel layers. Optionally, the lubricant layer is at least coextensive with the display region of the flexible display layer.

In some embodiments, a lubricant is a compound capable of reducing the friction coefficient between two surfaces, e.g., two surfaces of two adjacent flexible panel layers. Examples of lubricants include mineral oil, natural oil, synthetic oil, silicon lubricant, polyols and esters. Optionally, the lubricant is a hydrophobic lubricant. Optionally, the lubricant is a lubricant that also has adhesion property. Nonetheless, in a structure having two flexible panel layers and a lubricant layer sandwiched therein between according to the present disclosure, the two flexible panel layers are capable of sliding relative to each other, e.g., when the flexible display apparatus is bent.

In some embodiments, the first flexible panel layer has a larger dimension than that of the second flexible panel layer along at least a first direction. For example, the first flexible panel layer has a dimension no more than 25% (e.g., no more than 20%, no more than 15%, no more than 10%, no more than 5%) larger than the second flexible panel layer along at least a first direction. Optionally, the first flexible panel layer may have a larger dimension than that of the second flexible panel layer along a principal curvature direction.

In some embodiments, the lubricant layer has a larger dimension than that of the second flexible panel layer along at least a first direction. For example, the lubricant layer has a dimension no more than 25% (e.g., no more than 20%, no more than 15%, no more than 10%, no more than 5%) larger than the second flexible panel layer along at least a first direction. Optionally, the lubricant layer may have a larger dimension than that of the second flexible panel layer along a principal curvature direction.

Optionally, the lubricant layer has a dimension substantially the same as the second flexible panel layer.

In some embodiments, the first flexible panel layer has a larger dimension than that of the lubricant layer along at least a first direction. For example, the first flexible panel layer is still substantially coextensive with the lubricant layer, but has a dimension no more than 25% (e.g., no more than 20%, no more than 15%, no more than 10%, no more than 5%) larger than the lubricant layer along at least a first direction. Optionally, the first flexible panel layer has a larger dimension than that of the lubricant layer along a principal curvature direction.

Optionally, the lubricant layer has a dimension substantially the same as the first flexible panel layer.

Optionally, the first flexible panel layer has a larger (e.g., no more than 25%, no more than 20%, no more than 15%, no more than 10%, no more than 5%) dimension than those of the lubricant layer and the second flexible panel layer along at least a first direction; and the lubricant layer has a larger (e.g., no more than 25%, no more than 20%, no more than 15%, no more than 10%, no more than 5%) dimension than that of the second flexible panel layer along at least the first direction.

In some embodiments, the flexible display apparatus further includes at least one lubricant storage recess in at least one of the first flexible panel layer and the second flexible panel layer for storing lubricant. Optionally, at least one lubricant storage recess for storing lubricant is in a peripheral region of at least one of the first flexible panel layer and the second flexible panel layer. Optionally, the lubricant storage recess is in a peripheral region of the first flexible panel layer. Optionally, the lubricant storage recess is in a peripheral region of the second flexible panel layer.

By having a lubricant layer between the first flexible panel layer and the second flexible panel layer, the first flexible panel layer and the second flexible panel layer are capable of sliding relative to each other when the flexible display apparatus is bent or folded. As a result, the flexible display apparatus is free of defects and damages between the first flexible panel layer and the second flexible panel layer in the overlapping zone, e.g., the bubble defect, the wrinkle defect, and the scratching damage.

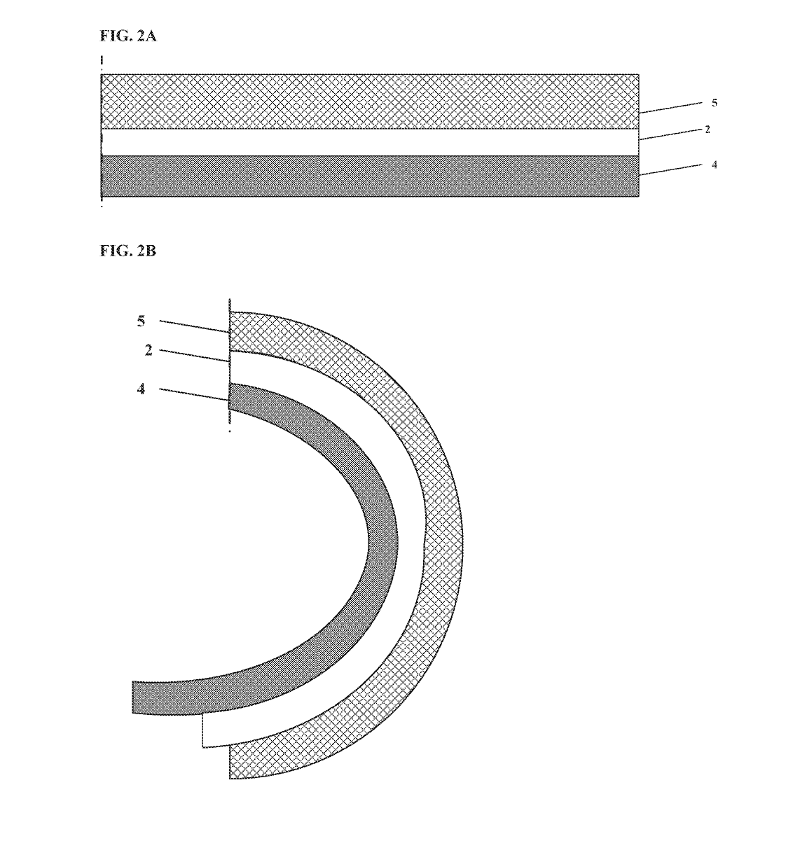

FIG. 2A is a diagram illustrating the structure of a flexible display apparatus in a flat state in some embodiments. FIG. 2B is a diagram illustrating the structure of a flexible display apparatus in a curved state in some embodiments. Referring to FIGS. 2A and 2B, the flexible display apparatus in the embodiments include at least two flexible panel layers 4 and 5 and a lubricant layer 2 between the two flexible panel layers 4 and 5.

By having a lubricant layer 2 between two flexible panel layers 4 and 5, the interaction forces between two flexible panel layers 4 and 5 can be much reduced. When the present flexible display apparatus is subject to a bending of a large degree, the bending stress can be rapidly released. Thus, the present flexible display apparatus is more foldable as compared to the conventional flexible display apparatus. When small particles are present on the surface of the flexible panel layer or in the lubricant layer, they are not pressed against the surface of the flexible panel layers due to the nature of the lubricant. Therefore, the scratching damages from these small particles are much reduced or eliminated, leading to a much higher product quality.

In some embodiments, the at least two flexible panel layers 4 and 5 includes a flexible display layer 4 for image display and one or more other flexible panel layers 5 on one or both sides of the flexible display layer 4. The flexible display layer 4 may be any appropriate flexible display layer, such as a flexible organic light emitting display layer or a flexible liquid crystal display layer. Examples of other flexible panel layers 5 include, but are not limited to, a touch control layer, an optical layer, a polarization layer, an anti-scratch layer, a fingerprint resistant layer, an anti-glare layer, a heat dissipating layer, and an anti-static layer.

In some embodiments, the flexible display layer 4 has a larger area than that of one or more flexible panel layers 5 in plan view of the flexible display layer 4. Optionally, the flexible display layer 4 is wider than one or more flexible panel layers 5 on one side of the display apparatus in plan view of the flexible display layer 4. Optionally, the flexible display layer 4 is wider than one or more other flexible panel layers 5 on more than one side of the display apparatus (e.g., on two, three, or four sides) in plan view of the flexible display layer 4.

Optionally, the display apparatus includes more than one other flexible panel layers 5 on one side of the flexible display layer 4. Optionally, the display apparatus includes more than one other flexible panel layers 5 on either side of the flexible display layer 4.

The lubricant layer 2 may be made of any appropriate lubricant. Optionally, the lubricant is a transparent lubricant for maintaining a good light transmission in the flexible display apparatus. Optionally, the transparent lubricant is made of a mineral oil and a thickener. Optionally, the transparent lubricant is made of a lubricating oil and a thickener. The transparent lubricant adheres two adjacent flexible panel layers 4 and 5 together. Due to its lubricating property, the transparent lubricant reduces the interaction force between these flexible panel layers 4 and 5. By sealing the gap between two adjacent flexible panel layers 4 and 5, it prevents small particles such as dusts from getting into the space between two adjacent flexible panel layers 4 and 5.

The lubricant suitable for making the lubricant layer 2 may have various apparent colors in an enriched state (e.g., a large thickness). For example, the lubricant in the enriched state may be transparent, semi-transparent, white, black, or beige. The lubricant layer 2 may be made as a thin layer having a small thickness such that the lubricant layer 2 is transparent or semi-transparent regardless the lubricant's apparent color in the enriched state. Optionally, the lubricant layer 2 is made of a lubricant that is transparent or semi-transparent in its enriched state.

Optionally, the lubricant layer 2 has a thickness in the range of about 10 to about 300 μm. A thickness in this range would not meet the requirement for thin film interference, moire is not generated under this condition. Thus, the display quality of the flexible display apparatus may be improved.

Optionally, the lubricant layer 2 has a thickness in the range of about 40 μm to about 60 μm. A thickness in the range results in a thinner display apparatus, and prevents contamination of flexible panel layers 4 and 5 from foreign objects such as dusts.

In another aspect, the present disclosure provides a method of fabricating a flexible display apparatus having a lubricant layer 2, e.g., between the flexible display layer 4 and the flexible panel layer 5. In some embodiments, the method includes coating the flexible display layer 4 with a lubricant, placing the flexible panel layer 5 on the lubricant, pressing the flexible panel layer 5 with a roller to adhere the flexible panel layer 5 onto the flexible display layer 4. The thickness of the lubricant layer 2 may be adjusted by adjusting the pressure of the roller on the flexible panel layer 5, which can be adjusted by changing the distance between the roller and the flexible display layer 4.

In some embodiments, the method includes coating the flexible panel layer 5 with a lubricant, placing the flexible display layer 4 on the lubricant, pressing the flexible display layer 4 with a roller to adhere the flexible display layer 4 onto the flexible panel layer 5. The thickness of the lubricant layer 2 may be adjusted by adjusting the pressure of the roller on the flexible display layer 4, which can be adjusted by changing the distance between the roller and the flexible panel layer 5.

In some embodiments, the method includes coating the flexible panel layer 5 with a lubricant, and adhering the flexible display layer 4 and the flexible panel layer 5 in vacuum.

By having a lubricant layer 2 between two flexible panel layers 4 and 5, the interaction forces between two flexible panel layers 1 can be greatly reduced. When the present flexible display apparatus is subject to a bending of a large degree, the bending stress can be rapidly released. Thus, the present flexible display apparatus is more foldable as compared to the conventional flexible display apparatus. When small particles are present on the surface of the flexible panel layers 4 and 5, or in the lubricant layer 2, they are not pressed against the surface of the flexible panel layers due to the nature of the lubricant. Therefore, the scratching damages from these small particles are much reduced or eliminated. Product quality can be improved due to the reduction or elimination of the scratching damages. Moreover, the manufacturing costs of the flexible display apparatus can be lowered by replacing the more expensive adhesive material in the convention display panel with a lubricant.

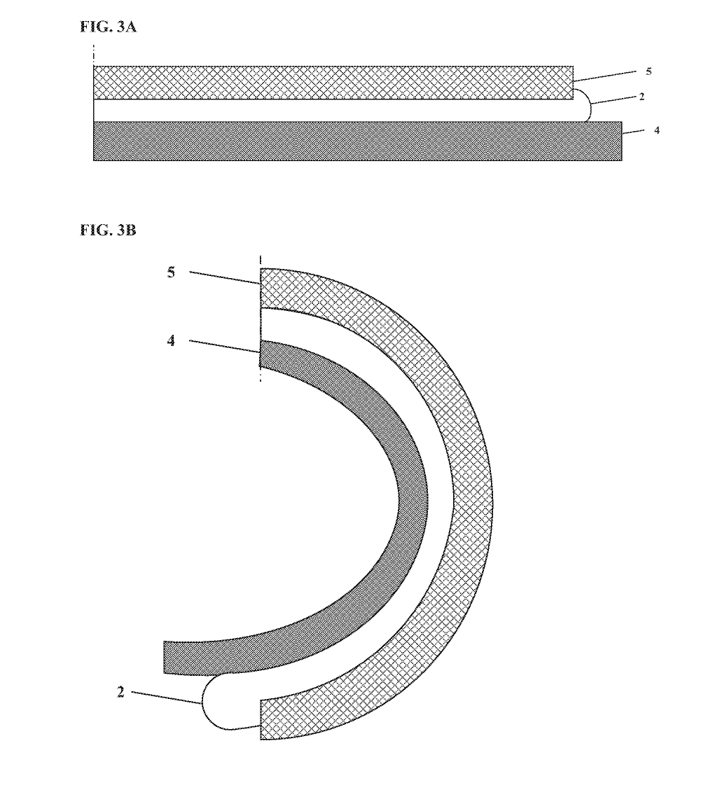

FIG. 3A is a diagram illustrating the structure of a flexible display apparatus in a flat state in some embodiments. FIG. 3B is a diagram illustrating the structure of a flexible display apparatus in a curved state in some embodiments. Referring to FIGS. 3A and 3B, the flexible display apparatus in the embodiments include two flexible panel layers 4 and 5, and a lubricant layer 2 between the two flexible panel layers 4 and 5. The flexible panel layer 4 in the embodiment has a larger dimension than the flexible panel layer 5 along at least a first direction. For example, the flexible panel layer 4 has a larger dimension than the flexible panel layer 5 along at least the curvature direction (e.g., the principal curvature direction). Optionally, the lubricant layer 2 has a larger dimension than the flexible panel layer 5 along the first direction, and has a smaller dimension than the flexible panel layer 4 along the first direction. By having this design, the lubricant layer 2 may expand and contract upon external environment change such as ambient temperature change so that there is always adequate lubricant between the flexible panel layer 4 and the flexible panel layer 5. An uneven thickness of the lubricant layer 2 due to inadequate lubricant or formation of bubble therein can be prevented. Optionally, the flexible panel layer 4 is a flexible display layer. Optionally, the flexible display layer 4 has a larger dimension than the flexible panel layer 5 along the first direction (e.g., the principal curvature direction). Optionally, the lubricant layer 2 has a larger dimension than the flexible panel layer 5 along the first direction, and has a smaller dimension than the flexible display layer 4 along the first direction.

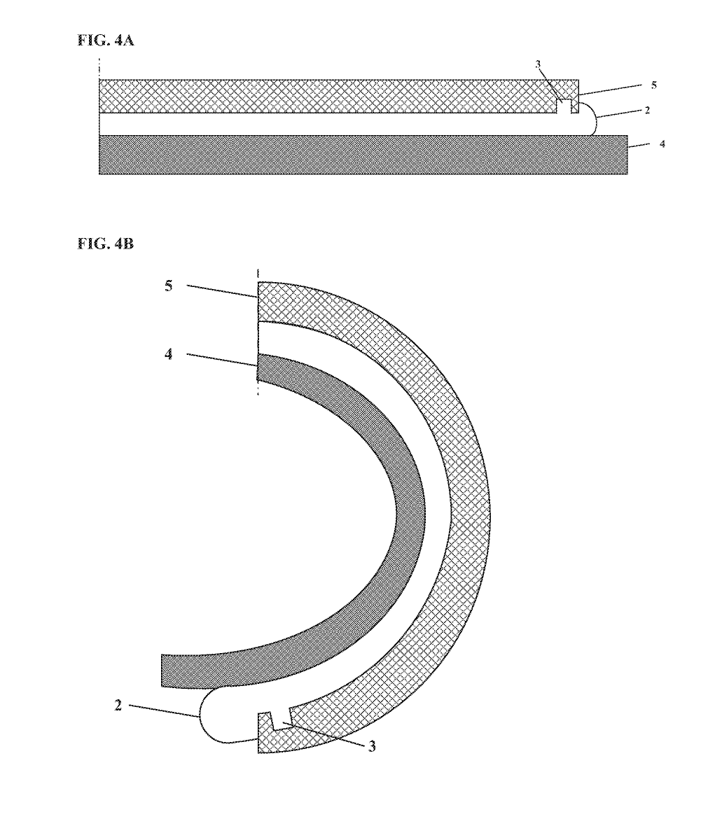

FIG. 4A is a diagram illustrating the structure of a flexible display apparatus in a flat state in some embodiments. FIG. 4B is a diagram illustrating the structure of a flexible display apparatus in a curved state in some embodiments. Referring to FIGS. 4A and 4B, the flexible display apparatus in the embodiment includes at least one lubricant storage recess 3 in at least one of two adjacent flexible panel layers 4 and 5 for storing lubricant from a lubricant layer 2 between the two adjacent flexible panel layers 4 and 5. Optionally, the flexible display apparatus may include more than one lubricant storage recesses 3 in one or both of the two adjacent flexible panel layers 4 and 5. The lubricant storage recess 3 stores lubricant in the lubricant layer 2 when the lubricant is in excess in the lubricant layer 2. When the volume of lubricant in the lubricant layer 2 decreases due to retraction caused by temperature change or wear out by long term use, the lubricant layer 2 can be supplemented with the lubricant in the lubricant storage recess 3. That ensures that the lubricant layer 2 is sufficiently filled with the lubricant. An uneven thickness of the lubricant layer 2 due to inadequate lubricant or formation of bubble therein can be prevented. By having a lubricant storage recess 3, the size of the display panel frame can be further minimized.

Various embodiments may be practiced to make the lubricant storage recess 3. The lubricant storage recess 3 may have any appropriate shape and dimension. Examples of shapes include, but are not limited to, a rectangular shape, a round shape, and a bar shape.

Any appropriate flexible display layer 4 may be used for making the present flexible display apparatus. Examples of flexible display layers 4 include, but are not limited to, flexible organic light emitting display layers, flexible liquid crystal display layers, and flexible electronic paper display layers.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A flexible display apparatus, comprising at least a first flexible panel layer and a second flexible panel layer, and a lubricant layer between the first flexible panel layer and the second flexible panel layer; wherein the first flexible panel layer and the second flexible panel layer are capable of sliding relative to each other when the flexible display apparatus is bent.

2. The flexible display apparatus of claim 1, wherein the first flexible panel layer and the second flexible panel layer overlapping with each other in plan view of the flexible display apparatus forming an overlapping zone; the lubricant layer is in contact with the first flexible panel layer substantially throughout the overlapping zone and in contact with the second flexible panel layer substantially throughout the overlapping zone.

3. The flexible display apparatus of claim 1, wherein the first flexible panel layer has a larger dimension than those of the lubricant layer and the second flexible panel layer along at least a first direction; and the lubricant layer has a larger dimension than that of the second flexible panel layer along at least the first direction.

4. The flexible display apparatus of claim 3, wherein the first direction is a principal curvature direction.

5. The flexible display apparatus of claim 3, further comprising at least one lubricant storage recess for storing lubricant in a peripheral region of at least one of the first flexible panel layer and the second flexible panel layer.

6. The flexible display apparatus of claim 5, comprising two lubricant storage recesses.

7. The flexible display apparatus of claim 1, wherein the first flexible panel layer, the second flexible panel layer, and the lubricant layer are substantially coextensive with each other.

8. The flexible display apparatus of claim 1, wherein the lubricant layer has a thickness in the range of about 10 μm to about 30 μm.

9. The flexible display apparatus of claim 8, wherein the lubricant layer has a thickness in the range of about 40 μm to about 60 μm.

10. The flexible display apparatus of claim 1, wherein the first flexible panel layer is a flexible display layer for image display.

11. The flexible display apparatus of claim 10, wherein the flexible display layer is selected from the group consisting of a flexible organic light emitting display layer, flexible liquid crystal display layer, and flexible electronic paper display layer.

12. The flexible display apparatus of claim 10, wherein the flexible display layer has a larger dimension than those of the lubricant layer and the second flexible panel layer along at least a first direction; and the lubricant layer has a larger dimension than that of the second flexible panel layer along at least the first direction.

13. The flexible display apparatus of claim 10, wherein the flexible display layer, the second flexible panel layer, and the lubricant layer are substantially coextensive with each other.

14. The flexible display apparatus of claim 1, wherein the second flexible panel layer is selected from the group consisting of a touch control layer, an optical layer, a polarization layer, an anti-scratch layer, a fingerprint resistant layer, an anti-glare layer, a heat dissipating layer, and an anti-static layer.

15. The flexible display apparatus of claim 1, wherein the lubricant layer is made of a transparent lubricant.

16. The flexible display apparatus of claim 15, wherein the transparent lubricant is made of a thickener and at least one of a mineral oil and a lubricating oil.

17. The flexible display apparatus of claim 16, wherein the transparent lubricant has an enriched state color selected from the group consisting of transparent, semi-transparent, white, black, and beige.

18. The flexible display apparatus of claim 1, comprising a plurality of flexible panel layers and a plurality of lubricant layers, each lubricant layer between each pair of two adjacent flexible panel layers.

19. The flexible display apparatus of claim 1, wherein the lubricant layer is at least coextensive with a display region of the flexible display apparatus.

20. The flexible display apparatus of claim 1, wherein the overlapping zone is at least coextensive with a display region of the flexible display apparatus.
